(19) United States
(12) Patent Application Publication
(10) Pub. No.: US 2004/0160464 A1
(43) Pub. Date: Aug. 19, 2004

(54) System and method for providing a graphical user interface and alternate mappings of management information base objects

(76) Inventor: David Reyna, San Francisco, CA (US)

Correspondence Address: Fay Kaplun & Marcin, LLP, Suite 702, 150 Broadway, New York, NY, 10038, US

(21) Appl. No.: 10/368,223

(22) Filed: Feb. 14, 2003

(51) Int. Cl. G09G 5/00

(52) U.S. Cl. 345/854

(57) ABSTRACT

A method and system to provide a graphical user interface for manipulation of Management Information Base Objects is described. A hierarchical tree of the MIB objects is generated and displayed, so that each node of the tree can be expanded, contracted or edited. The position of the nodes on the tree may also be edited. A web page or a CLI command tree can be generated also displaying the editable MIB tree, and handler functions to implement the MIB functions may be generated.

### BACKGROUND INFORMATION

In a computer network, data can be transferred between interconnected devices that are able to receive information and transmit information to other devices in the network. A network may include computer and non-computer devices capable of information transmission. Embedded devices are one example of non-computer devices that are capable of transmitting and receiving information via a network and web servers. Embedded devices, or devices containing embedded code and elements to execute the code, may be programmable and are generally used to control or monitor processes, machinery, environments, equipment, communications and other functions or elements. Examples of embedded devices include personal digital assistants (PDA's) and mobile telephones.

Embedded devices have become popular because they are portable, can communicate over a network, and are capable of management via the Internet. The popularity of embedded devices has also increased because web browsers and protocols promote wide data accessibility from virtually anywhere. Control and monitoring of these network devices requires a system in which internal variables of the device can be accessed, monitored, and if necessary changed. These variables can be data generated within the device, or can be control parameters that modify operation of the network device. In many cases the internal variables are accessed from outside the device, for example from a remote control console. In some cases, different elements within the device itself perform monitoring and control functions over other elements.

One method of accessing internal variables of network devices is to use Management Information Base (MIB) objects. MIB objects are variables residing on the network device, that describe the state of the device. They can be manipulated by using functions that read and can modify the variables. For example, “get” and “set” Protocol Data Unit (PDU) functions are used respectively to monitor and to change the MIB objects of a device. However, manipulation of MIB objects of a network device requires a complicated procedure, which is time consuming and has to be performed by experienced personnel. This is a drawback, especially because new network devices are designed at a rapid pace, and it is necessary to develop systems to access data from those devices equally rapidly.

### SUMMARY OF THE INVENTION

In one aspect, the present invention is a method of editing MIB objects of a networked device which includes developing a MIB tree representing the hierarchical MIB objects of the networked device, generating a graphical user interface to interactively edit the MIB tree, and displaying the MIB tree in the graphical user interface as a selected graphical representation, the selected graphical representation being equivalent to the MIB tree. The method also includes providing editable fields of the selected graphical representation such that edited fields are mapped to the MIB tree and generating an edited MIB tree comprising the mapped edited fields. The selected graphical representation can be a CLI command tree or may comprise linked HTML web pages.

In another aspect, the present invention is a system for accessing MIB objects of a networked device, comprising a graphical user interface to display a MIB tree representing the MIB objects, a GUI engine to generate in the graphical user interface a selected graphical representation equivalent to the MIB tree, and dialog boxes generated in the graphical user interface to receive commands and parameters for the GUI engine.

In yet another embodiment, the invention is a system to remotely access device variables of a networked device, which includes a MIB compiler to generate a MIB tree from MIB objects corresponding to the device variables, a GUI engine to map and display the MIB tree as a selected graphical representation, dialog boxes of the selected graphical representation adapted to receive commands and variables for the GUI engine, and editable fields of the selected graphical representation adapted to receive editing instructions to modify corresponding elements of the MIB tree.

### BRIEF DESCRIPTION OF THE DRAWINGS

FIG. 1 is a diagram showing the hierarchical tree structure of MIB objects for a device, according to the present invention;

FIG. 2 shows an exemplary graphical user interface for a MIB compiler according to the present invention;

FIG. 3 shows a flow chart of an exemplary process for converting a MIB tree into a CLI tree, according to embodiments of the present invention;

FIG. 4 shows a flow chart of an exemplary process for converting a MIB tree into a web page, according to embodiments of the present invention;

FIG. 5 shows an exemplary dialog box to control conversion between a MIB tree and a corresponding CLI tree;

FIG. 6 shows an exemplary dialog box to control conversion between a MIB tree and a corresponding web page;

FIG. 7 shows an exemplary output CLI tree, generated according to embodiments of the present invention;

FIG. 8 shows an exemplary output web file generated according to embodiments of the present invention;

FIG. 9 shows an exemplary output web page generated according to embodiments of the present invention;

FIG. 10 shows a flow chart of an exemplary process for generating a CLI scalar handler, according to embodiments of the invention;

FIG. 11 shows a flow chart of an exemplary process for generating a CLI table handler, according to embodiments of the invention;

FIG. 12 is a block diagram of an exemplary MIB GUI system according to an embodiment of the invention; and

FIG. 13 is a block diagram of a system to convert a MIB tree to a CLI or HTML representation, according to an embodiment of the invention.

### DETAILED DESCRIPTION

The present invention can be further understood with reference to the following description of preferred exemplary embodiments and the related appended drawings, wherein like elements are provided with the same reference numerals. Embodiments of the present invention will be described with reference to embedded devices and operating systems used in embedded devices. However, those skilled in the art will understand that the present invention is not limited to embedded devices, but can be used with any device utilizing internal variables describing or controlling the state of the device, such that the variables can be accessed using MIB objects.

In the context of this specification, the term developer is used to describe the individual responsible for developing the device or the set of commands to manipulate the internal variables of the device, such as by adding new variables, deleting variables, or modifying existing variables. The term user generally refers to the person that may be using the device or issuing the commands to manipulate the variables, such as by entering CLI commands to retrieve or modify the variables. However, these terms may be use interchangeably throughout this description.

Embodiments of the present invention describe a method of displaying and modifying performance and state parameters as described by MIB objects used in the SNMP network protocol. These parameters can be thought of as ordered members of a hierarchical tree. In addition, this hierarchical tree can be visually presented to the user in a tree format using a Graphical User Interface (GUI), allowing the user to easily manipulate and modify the representation of the parameters. The embodiments presented also describe a method and system by which this set of parameters can be accessed and manipulated by alternate interface protocols, given that these protocols can also be ordered in a hierarchical tree form. An automated mapping of parameters between the interfaces is also provided. Exemplary embodiments of the present invention explicitly describe the transformation of the MIB tree ordering of the parameters into a Command Line Interface (CLI) command set syntax, and into a set of linked Web HTML pages.

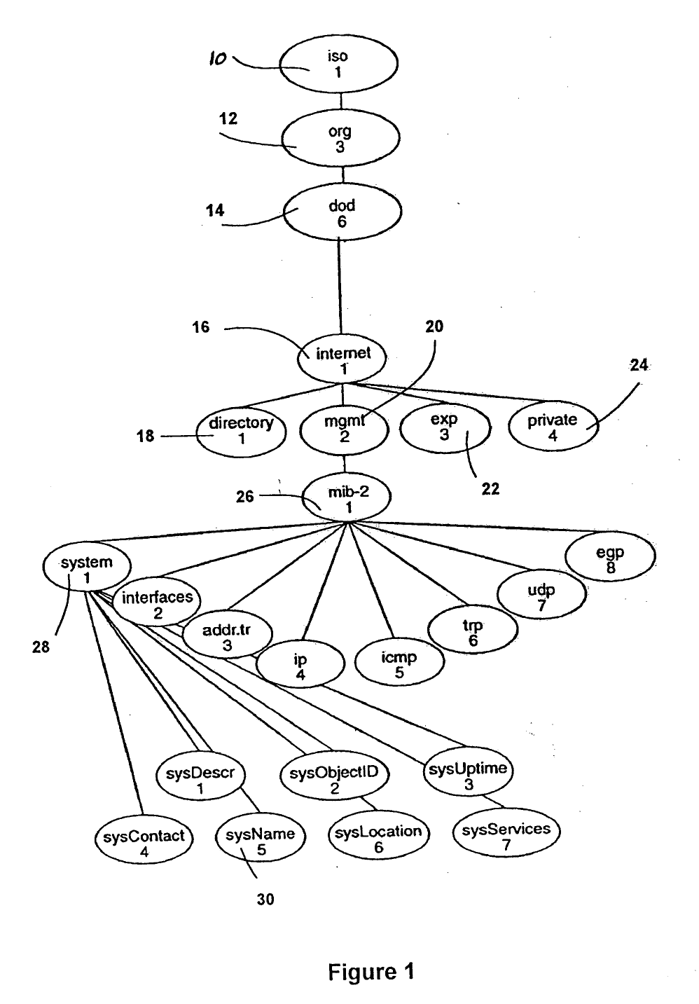

FIG. 1 shows an exemplary structure of the Management Information Base (MIB) objects for a generic device. Exemplary MIB tree 1 is a representation of the hierarchical structure of the variables used to access the network device. In this case, the MIB tree 1 follows a standard hierarchy specified by the Structure of Management Information (SMI), a generally recognized standard that is known in the art. This hierarchy is the standard used in Simple Network Management Protocol (SNMP), which is an exemplary protocol generally used to communicate between networked devices. SNMP is a good starting point for generating other management interfaces, because there are many industry-defined MIB's for Internet standards, and because the MIB's under SNMP define the actual management data elements in addition to their organization.

Elements 10 through 16 shown in FIG. 1 form a prefix that is included in all MIB objects under SNMP. Thus, every MIB object description will always start with the prefix 1.3.6.1, followed by the remainder of the name specification. One example of a MIB object 30 shown in FIG. 1 is sysName. sysName is part of the system group 28 of MIB's, which in turn is part of the MIB-2 group 26. MIB-2 is a part of the mgmt (management) group 20, which together with directory group 18, experimental group 22 and private group 24 forms a layer under the internet group 16. System group 28 represents a standard set of MIB objects that are implemented on virtually every network device that uses SNMP for packet based communications. In this example, the MIB object sysName would have the following full hierarchical specification, called an object identifier (OID):

iso.org.dod.internet.mgmt.mib-2.system.sysName

In numerical form, the specification would be: 1.3.6.1.2.1.1.5. As indicated, under SNMP any device's MIB agent and external command console would know this hierarchy, and would be able to access the MIB object specified in this manner.

The OID described above includes only a base portion, because it refers to a MIB object that accesses a scalar variable of the device. If the variable was a table variable, such that a multi dimensional matrix of values was accessed, the OID would also include an instance portion, specifying which one of the variables in the matrix is to be read or modified.

When a command console external to the device seeks to retrieve or modify the variable associated with a MIB object, such as sysName, SNMP provides the appropriate functions to do so. The external command console can be, for example, another network device that requires data from the device being queried, a client computer that wants to retrieve the data or set some parameters of the device, a web server within the device that generates a web page usable to access the device, or any other entity set up to access data and parameters of the device. Similarly, developers of the device may want to access the data to test the suitability of already existing MIB objects, to modify those MIB objects and to create new ones.

To access data of the network device, the console sends GET or SET Protocol Data Units (PDU) calls, which are standard under SNMP, and which specify the OID for the MIB object to be used, and any necessary value to be set in the variable. The GET and/or SET PDU's can be sent, for example, through a network connecting the device to the console. When the PDU is received by the device, a SNMP agent of the device consults a Management Information Base (MIB) also located in the device, to determine the specific function calls required to get or to modify the variables mapped to the MIB objects. The MIB is a set of mappings between the MIB objects OID's specified in the PDU calls, and the actual get or set routines, or handlers, specific to that device that are used to access the data. The SNMP agent of the device generally includes a module that is capable of receiving, parsing, building and sending to the console PDU's according to SNMP. The SNMP agent also has a MIB database that provides mappings to the get/set functions, as described above.

During development of devices, a great deal of engineering effort must be expended to design, define and describe the MIB objects of the device. Since each device is different, and the device architecture is designed differently by different developers, generating the MIB objects is a unique effort that must be undertaken for every different device. Another very significant effort is required to create the get and set functions, or handlers, that are used within the device to access the data to be sent out to the console via the OID's. Since every device is different, those handler functions must be custom made for each device. Although the MIB objects provide a standardized manner of accessing data of the device from outside of the device, a significant effort is required to build the MIB objects for a specific device, and especially to access the data within the device that is specified by the MIB objects.

According to embodiments of the present invention, a Graphical User Interface (GUI) is utilized to assist the developer in creating and editing MIB objects for use with network devices. To that end, the preferred embodiments according to the present invention includes a MIB compiler interface that presents the developer with an intuitive graphical representation that allows generation of a file that can be reviewed, edited, and sent to a MIB compiler for execution. Exemplary embodiments of the present invention also allow a user to generate a CLI tree that is equivalent to the original MIB tree containing the MIB objects described above. CLI provides a way for the user to type commands and see the results displayed back on the text screen. CLI provides immediate feedback, but requires a user very knowledgeable of the device's command set. In particular, a GUI is used to provide the developer with an intuitive way of generating the equivalent CLI tree.

The preferred embodiments according to the present invention may also generate the appropriate parameters and handlers associated with the CLI tree. Similarly, a web page matching the functionality of the SNMP GET and SET commands may be generated using the GUI. In one exemplary embodiment, a separate web page is provided for each handler, with edit boxes for each parameter and with links between CLI node pages. A web page created using HTML is suitable to be used by an end user not necessarily familiar with the device's command set. Web pages can be set up to guide inexperienced users to properly configure the device, and may be developed to have a professional look.

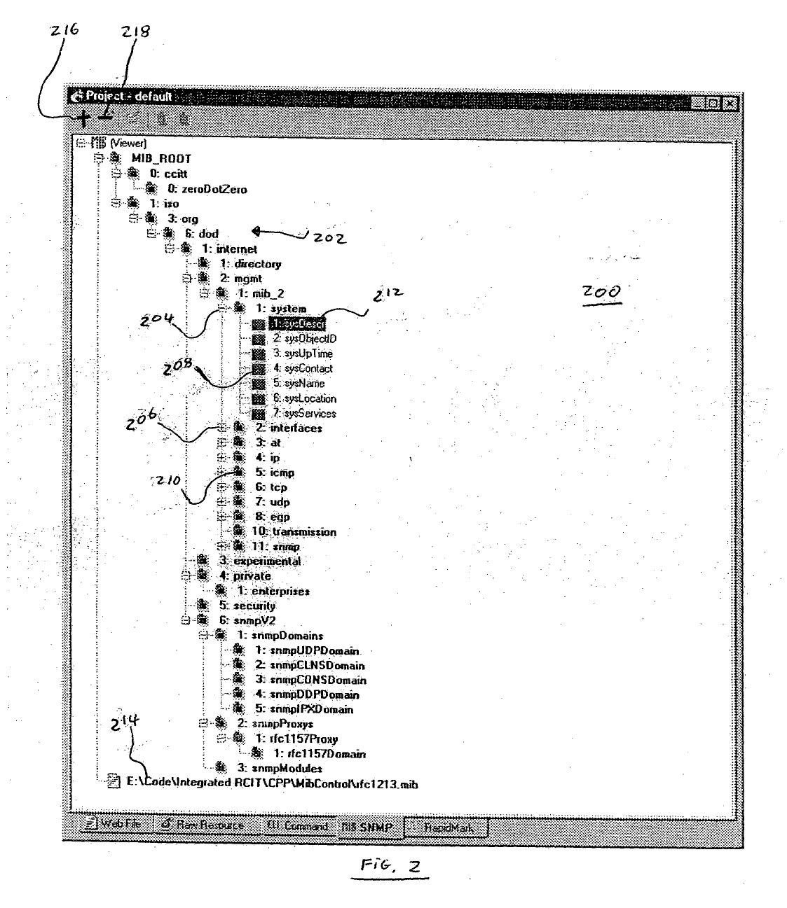

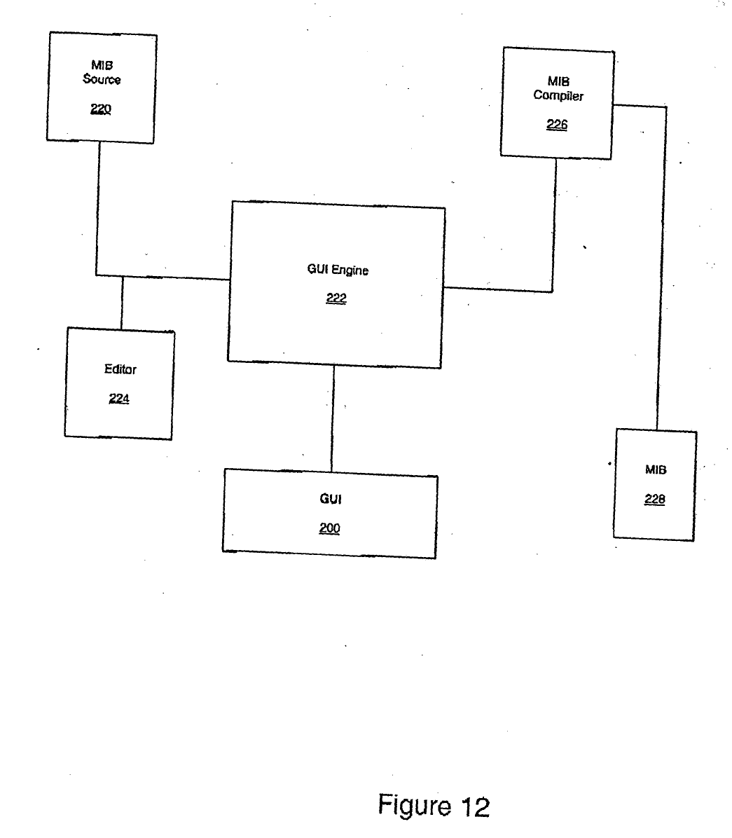

FIG. 2 shows an embodiment of a GUI used to display the hierarchical MIB tree according to the invention. FIG. 12 shows a block diagram of an exemplary MIB GUI system. In this example, the MIB viewer GUI 200 displays an exemplary portion of a MIB hierarchy stored, for example, in the same form as in MIB source 220. In this example, reference numeral 202 refers to the general prefix for MIB's of iso.org.dod.internet that was shown in FIG. 1 by numerals 10-16. MIB viewer 200 shows the hierarchical MIB objects in expandable/collapsible tree form, such that as much detail as required by the developer can be shown. For example, pressing the − button 204 removes the contents of node system from the display. Conversely, pressing + button 206 displays the contents of node interfaces. The generation of the graphical representation of the MIB tree shown in FIG. 2 may be carried out, for example, by a GUI engine comprising one or more graphic software applications used to generate interactive displays.

Different icons may be used in MIB viewer GUI 200 to depict different types of tree entities. Upper level nodes such as system and interfaces can be displayed by an icon 210, while MIB objects may have an icon 208. In the context of a hierarchical tree, the objects may be referred to as leaves. Depending on the type of node selected, different options may also be enabled for selection by the developer. For example, selecting a MIB leaf, may invoke a leaf viewer which may display the name of the MIB object, the type and access properties. In addition, the leaf viewer may also display the names of functions used to get, set and change the MIB object in question. Selecting an object in MIB viewer 200 may also invoke an editor 224 which may display the source code of the object.

With reference to FIG. 2, add and delete buttons 216, 218 may also be provided. Add button 216 may be used to generate a new MIB object. When the developer presses add button 216, a MIB editor screen may be displayed where the developer can specify the parameters required to create a new MIB object. Delete button 218 may be used to discard an existing MIB object. For example, a MIB object can be highlighted and button 218 can be pressed to delete it. In addition, the location of MIB objects may also be changed through MIB viewer 200. For example, the developer may highlight a MIB object such as sysContact 208, and may move it to another location within the MIB tree structure, such as under node 210, icmp. The system then automatically generates the new OID from the MIB objects edited. After viewing and/or performing modifications of the MIB tree, the MIB tree may be provided to a MIB compiler 226, which creates an executable version of the MIB 228. The executable version can then be used, for example, in a networked device.

Having the MIB's represented in a tree format is very useful, because it provides a visual representation of the MIB structure. In addition, embodiments of the GUI engine according to the present invention allow the developer to “cut and paste” the various parts of the tree into other protocols that are also represented as trees. For example, portions of the MIB tree may be highlighted and dragged to an equivalent CLI tree, and may be converted to corresponding portions of the CLI command set or Web page sets. This ability simplifies considerably the work of the developer, since many devices that are controlled through MIB's have very different interfaces which require the developer to have knowledge and skills in multiple protocols. The GUI engine according to the invention makes it possible for a developer that is not an expert in the specific protocol used by the device to access the data from the device.

According to the invention, the developer can copy nodes and branches of the MIB tree to a different selected graphical representation, for example a CLI command tree. The GUI engine then translates the MIB tree to a form that is compatible with the CLI protocol, while retaining for the developer manual control of the placement of the tree nodes. In one exemplary embodiment, the transition from MIB tree to CLI tree is performed as follows. An industry standard MIB is selected and is compiled using a suitable compiler, as described above with reference to FIG. 2 and FIG. 12, to generate the graphical tree representation. The developer then may paste branches of the MIB tree to the CLI tree, while the GUI engine performs all the necessary protocol translations to create a working corresponding CLI command, as described below. The GUI engine generates commands that display and set the scalars and tables of the MIB nodes, and recursively generates command sub-nodes that reflect the structure of the source MIB tree elements.

After the protocol translations are carried out, the developer has working although unrefined CLI access to the variables of the device being accessed. This can be used to develop prototypes and proof of concept models of the CLI command structure. Using the GUI to display the CLI tree, the developer can then re-arrange these working CLI commands to their final configuration, suitable for release with the final product.

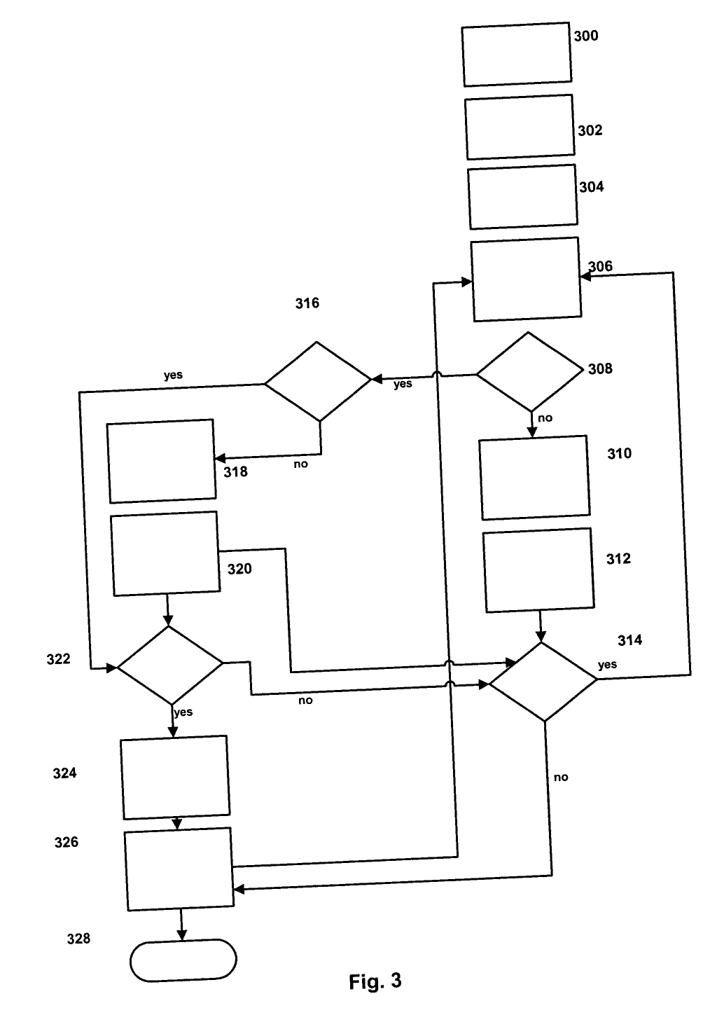

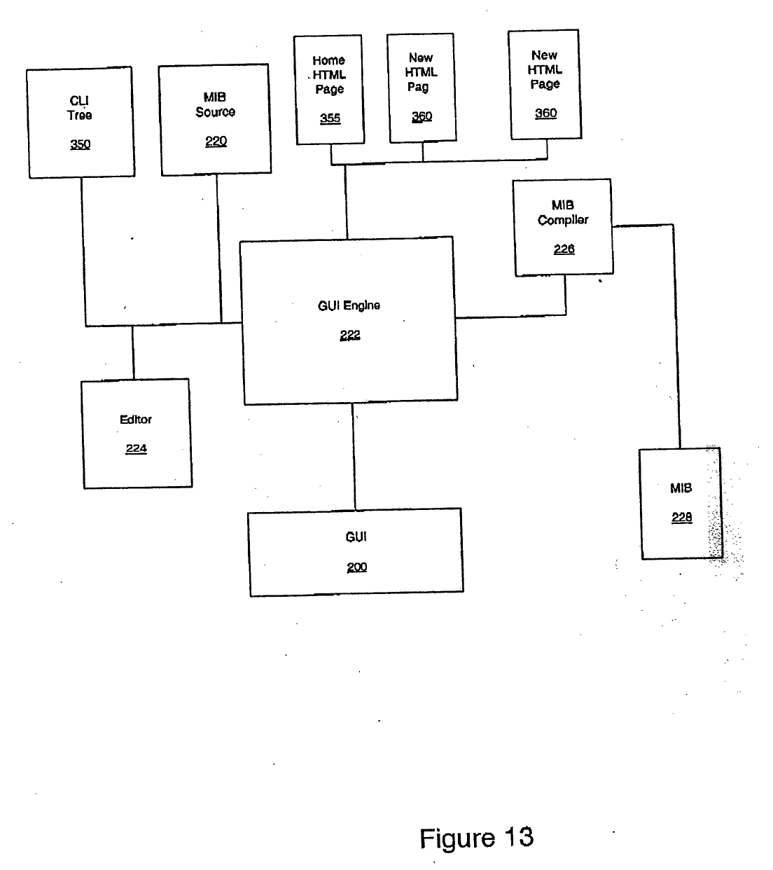

The process of converting elements of a MIB tree to corresponding elements in a CLI tree is described in greater detail in the following narrative related to an exemplary embodiment of the invention. The process may be better understood with reference to FIG. 3, depicting a flow chart of the steps involved, and FIG. 13 showing a block diagram of an implementing system. The process starts with step 300, in which the user selects the nodes in a MIB tree, such as the one depicted in FIG. 2, which are to be the source nodes for the new nodes of CLI tree 350. In step 302 the user selects a node in the CLI command tree 350 that will become the destination node, to which the new information will be appended. The user may select import options in step 304, for example by specifying whether read or write handlers will be generated by the GUI engine according to the invention.

Step 306 begins a loop in which each data object in the MIB source node is converted to an equivalent CLI node element. The first or next data object from the source MIB node is selected, and a determination is made in step 308 whether the object is a scalar or a table. If the object is a table, the process skips to step 316, otherwise the process continues to step 310. In step 310 the new CLI node is created, having the same name as the source MIB object. A parameter for the new node is created, with the same type as the source object. In step 312 a CLI command handler is created for the new node. The steps for generating the handler will be described in greater detail below. Step 314 concludes the present loop, by determining whether there are more objects in the MIB source node. If there are, the loop return to step 306 to select the next object. If not, the process ends at step 328.

Step 316 is reached if, in step 308, it is determined that the source object is a table. Step 316 further determines whether the MIB source object is a sub-node. If it is, the process goes to step 322, if not, the process goes to step 318. In step 318 the exemplary GUI creates a new CLI node using the title of the table, and for each scalar object in the table the GUI creates a parameter for the new node, having the same type as each source object. In step 320 a CLI command handler for the new CLI table node is generated, utilizing the options specified by the user in step 304. The process then returns to step 314, where the loop is repeated if there is a next object, or the process ends at step 328 if there are no more objects.

If it is determined in step 316 that the object is a sub-node, the process continues with step 322, where it is determined whether the user has allowed for the creation of sub-nodes in the CLI tree. If not, the process returns to step 314 to determine if there are more objects. If sub-nodes are allowed, step 324 is reached, in which a CLI sub-node is created using the name of the source MIB sub-node. In step 326, the GUI engine recursively repeats the process starting at step 306 using the current MIB sub-node as the source node, and the newly created CLI node as the destination. This recursive repetition is carried out until all the MIB sub-nodes have been processed, and have corresponding CLI sub-nodes. In this portion of the process, steps 308, 310, and 312 are repeated for all the source MIB sub-nodes. When all source MIB sub-nodes have been processed, the process is directed to step 314 where the next MIB source node is obtained, or the end 328 is reached.

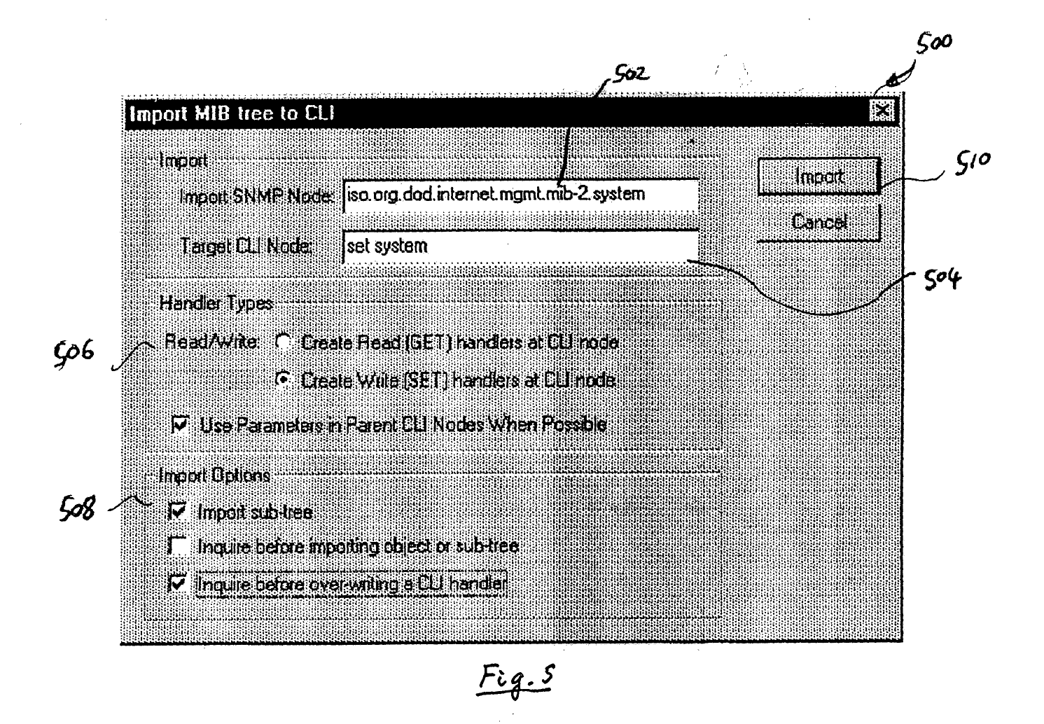

FIG. 5 shows an exemplary embodiment according to the invention of an interface dialog box that may be displayed as part of GUI 200 to the developer to import a MIB source tree to a CLI format. Dialog box 500 may include, for example, an import selection text box 502 in which the user may specify the import node that contains the source MIB object. The output selection text box 504 is used to specify the target CLI node where the new CLI commands, corresponding to the source MIB objects, will be placed. The source and target trees are thus selected by the user. Region 506 of dialog box 500 may include handler type options, such as read and/or write handlers, to allow the developer to request generation of handler functions. These options indicate whether the handler code that will be automatically generated, as described below, will display the data of the source objects, or whether to set up parameters in the CLI command that will be used to write to the objects and generate a write handler. Region 506 may include check boxes, radio buttons, or other types of graphical devices to specify the options. A “Use parameters in parent CLI nodes when possible” option may be included, to indicate that when generating the handler, already existing parameters in the current CLI tree should be used, rather than creating new similarly named parameters.

Import options may be specified in region 508. For example, options regarding import of sub-trees and handler generation may be selected in region 508. The “import sub-tree” option indicates whether to automatically create sub-nodes on the CLI tree for corresponding sub-nodes of the imported MIB tree. Command buttons 510 may be provided to allow the developer to initiate import of the source MIB objects, or to cancel the process.

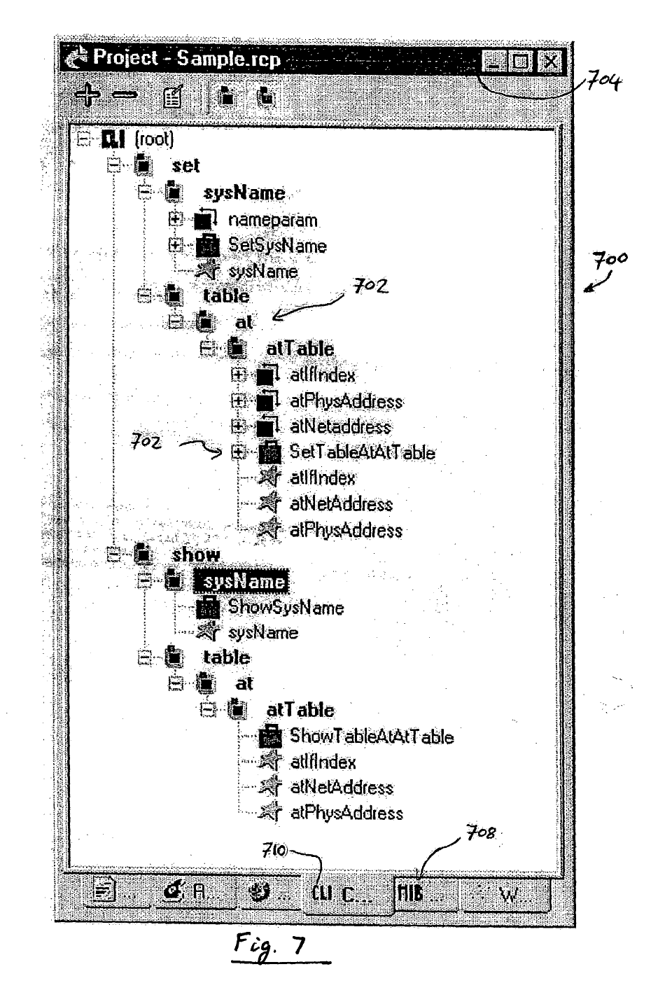

FIG. 7 shows an exemplary embodiment of a graphical representation of a CLI tree generated according to the present invention. The elements of the CLI tree shown in display 700 correspond to the elements of the MIB tree of FIG. 1, since the CLI tree is derived therefrom. For example, the branch “table:at:atTable” 702 may be depicted, with several sub folders 703 displayed underneath the “attable” folder. A title bar 704 may be used to describe the CLI tree that is being generated, corresponding to the name of the MIB object source tree from which the CLI tree was derived. A tab bar 708 may be included, for example at the bottom of display 700, allowing the developer to select which display window is depicted. In this exemplary depiction, tab 710 selects the display showing the CLI tree, while other tabs may select the source MIB tree, an HTML web page tree, etc.

As indicated above, it is beneficial to convert the MIB tree into another selected graphical representation, such as a web page representation that has the same functionality as the MIB commands. As in the case of the generation of a CLI tree, the process begins with the developer selecting an appropriate MIB and compiling it to obtain the MIB tree as described above. The developer may then copy and paste branches of the MIB tree into a corresponding parent HTML file, at selected locations in the HTML file. The GUI engine described above performs all the necessary protocol translations to generate a working HTML file, having the functionality of the source MIB tree. Text and edit fields may be created to allow a Web server to display and set the scalars and tables attached to the pasted MIB tree branch. HTML files may be recursively created to reflect the tree structure of the pasted MIB branches, including buttons to navigate back and forward through the HTML page set.

According to the invention, the HTML web page corresponding to the MIB tree may be displayed on a client's network device, such as a computer connected to the Internet. According to the process described above, selected contents of the MIB tree are rendered as a web page, remotely accessible by standard web browsers. Additional web pages may be generated when the developer expands or collapses the MIB tree, as described above, so that the newly expanded or collapsed tree may also be shown on the client computer. The system according to the invention may also include a web server or another type of network server, to make available through a network the web pages used to create and edit MIB objects. It will be apparent to one skilled int the art that the web pages may be made available to any networked computer connected to the web server through a Local Area Network (LAN), or a non local network such as the Internet.

Once the selected MIB tree source objects have been converted to Web pages, the developer is provided with a working web access to the variables of the device in question. This access may be restricted to a simple representation of the MIB tree as linked HTML web pages, sufficient to be used in developing prototypes and proof of concept models. The access may also include re-arranged elements and additional content and elements added to the basic HTML files to create a more polished web access interface that is suitable for inclusion in a finished product ready for release.

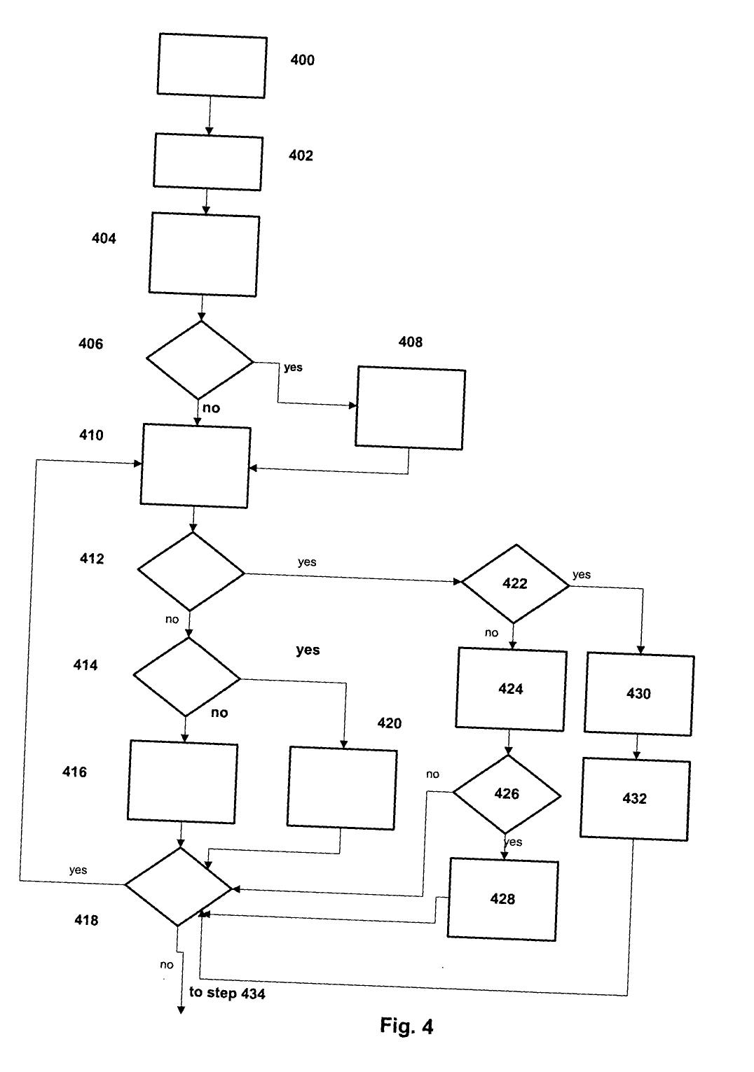

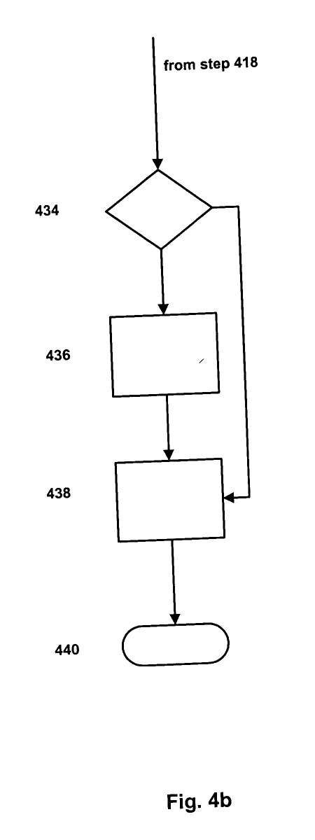

An exemplary process for converting imported MIB nodes into HTML files suitable to generate Web pages is described below, with reference to FIG. 4 and to the system shown in FIG. 13. In step 400 the developer selects a node in the MIB tree as the source node that will be transferred to an HTML page. Next, in step 402, the developer selects a home HTML file 355 that will be the root for the new page(s). The developer also indicates the import options to be used, such as whether the HTML pages will be read-only or read-write. In step 404 a link to a new HTML file 360 is inserted into the selected home web page 355, and the new HTML page 360 is created using the name of the MIB source node. User-selected header information may be added to the new page at this point.

A determination is made in step 406 whether the developer selected the read-write option. In that case, the procedure continues to step 408 where the HTML tag information to create an HTML form is inserted. Step 410 follows, or is reached directly if the read-write option was not selected. In step 410 a loop is started, in which the first or the next data object from the MIB source node is selected and processed. In step 412 the MIB object is evaluated to determine if it is a table. If so, the loop continues to step 422, which will be described below. If not, the next step 414 is reached, where it is determined if the read-write option was selected. If it was, the loop moves to step 420. If not, the loop continues to step 416, in which a line is inserted to display the object. The line may include a “Paragraph Begin” HTML tag, the name of the object, a special tag representing the data object, and a “Paragraph End” HTML tag. Step 418 further branches the process: if there are more objects in the source MIB node the loop returns to step 410. If there are no more objects, step 434 is reached.

Step 420 is reached from step 414 if the read-write option is selected, as described above. In this step, a line is inserted in the HTML file 360 to display the editable objects that will be found in the Web page. A “Paragraph Begin” HTML tag may be added, as well as the name of the source object. In addition, an “Edit Box” HTML tag may be included, with the value attribute including a special tag that represents the data object. A “Paragraph End” HTML tag may conclude the line. Once the proper line is inserted, the loop moves to step 418, and continues as described above.

Step 422 is designed to branch the execution of the process depending on whether the object is a sub-node or not. If the object is not a sub-node, step 424 is reached, in which a table is inserted in the HTML page 360. In step 424 the table's header is included, and text is added to create an HTML table with, for example, one row and the same number of columns as there are columns in the source table. Text is added to the columns so they will correspond to the names of the source objects. A tag may be added to begin a loop to output each row of the table. For example, the text “REPEAT(tablename, start, stop)” may be used, where the name of the table and the starting and ending rows replace the respective fields in the tag. Table HTML codes for the table rows may be included, to add special tags for each column member of the table, so that each special tag is placed in its respective column. Finally a special tag may be added to end the loop that outputs each row of the table. For example, the text “END(tablename)” may be used for this purpose.

At this point, if the read-write option was selected by the developer, step 426 sends execution of the process to step 428, to update table values. Otherwise, execution proceeds to step 418, and concludes as described above. In step 428 an HTML title text may be added, and for each column in the table may be added an HTML paragraph with the name of the column's object, a separator, and an HTML edit field with a tag indicating the object's name. An HTML button titled, for example, “Update Table” may be included, to cause the browser to post the HTML page to the server upon its selection. After these steps are completed, the process continues to step 418.

Step 430 is reached when a sub-node link is to be inserted. The HTML tag for a button linking to a new HTML page 360 is added, and is labeled with the sub-node's name. Step 404 is then recursively repeated using the current MIB sub-node as the new source node and proceeding from step 404 as described above (represented by step 432). The process then continues to step 418, as described above. Step 434 is reached from step 418 when there are no more objects to be processed in the MIB source node. Step 434 directs the process to step 438 if the read-write option is not selected. If that option is selected, the process goes to step 436, where an HTML tag is added to close the form block, and an HTML submit button is added, to post the form to the Web server. Step 438 is then reached, where user selected information, such as footer data, is added to the new web page 360. The conversion process from a MIB tree to a Web page is thus completed in end step 440.

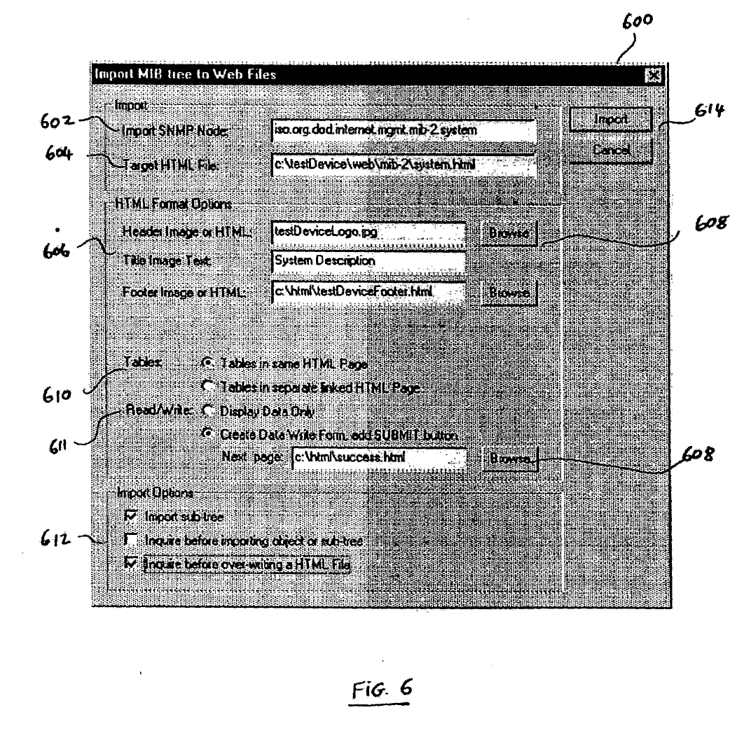

An exemplary dialog interface used to import a MIB tree to a web file is shown in FIG. 6. Dialog box 600 may include input field 602 where the developer may specify the source MIB tree object to be imported to the web file. Output field 604 may specify the target HTML file where the source node will be placed. The source and destination files for the process are thus defined by the developer. Various HTML format options may be specified by the developer in fields 606. For the “Header image or HTML” option the user can select an image file, such as a logo, that is placed at the top of the generated HTML file, or can select another HTML file to be used as a header. The “footer” option works in substantially the same manner as the header described above, and the “title” option allows the user to select text that will be displayed below the title image.

The “table” options of field 610 indicate whether a table will be shown in the same page as the parent data, or whether tables will be generated as separate HTML pages, linked to the rest of the data. The read/write fields 611, which may include radio buttons, indicate whether the data is displayed as text string tags, or whether it is displayed with edit box tags so that each element may be edited and submitted to be updated. The “Next Page” field indicates what page should be sent after the SUBMIT button is pressed in the web page. Import options 612 are made available so the developer may specify, for example, sub-tree options, and file over-writing options. Command buttons 614 are provided to let the developer import the selected source MIB tree object, or cancel the operation.

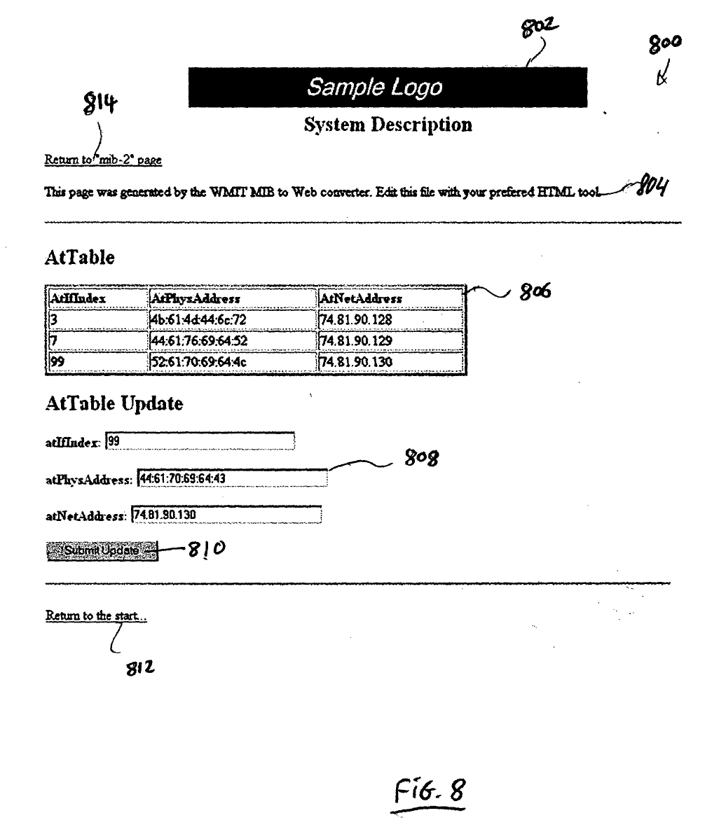

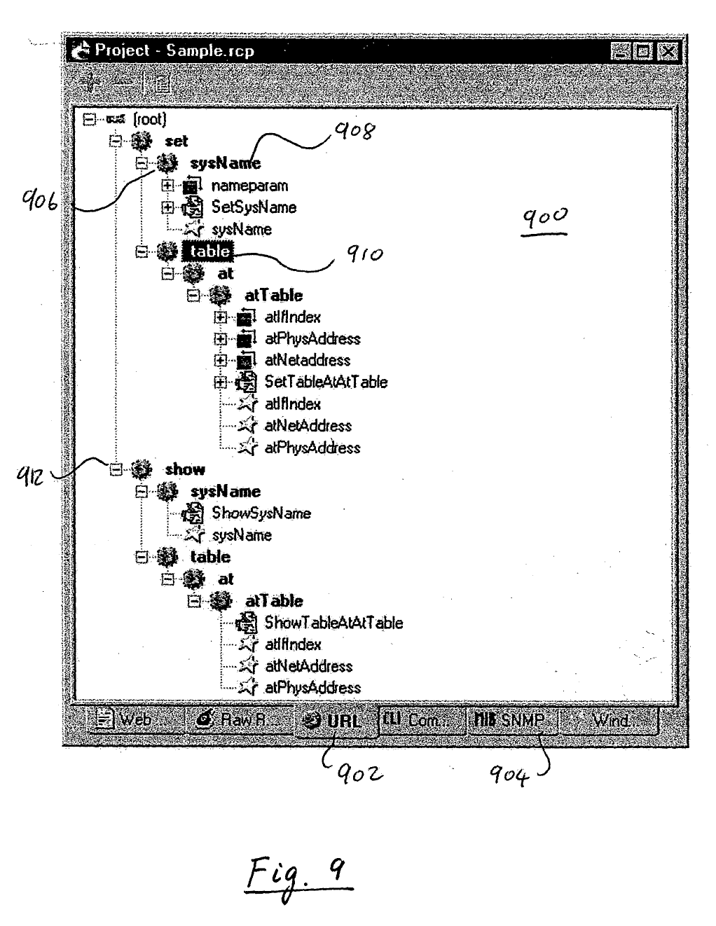

FIG. 8 shows an exemplary embodiment of a web page generated by the system according to the invention, as described above. Web page 800 may be generated, for example, from a branch of the source MIB object tree under the “MIB:At:AtTable” node. A sample logo region 802, with logo and textual messages, may be included in web page 800. A description of the source of the web page may be included in field 804. Field 806 may include the contents of the “AtTable” object, in a graphical interface that is easy to interpret. Editable fields 808 give the user the option of reviewing and changing the values of the object, and to submit the updated values to the MIB node using button 810. Hyperlinks or other HTML buttons may give the option of navigating up and down the MIB tree, for example with hyperlinks 812, 814, which respectively redirect to a “start” page and to a “mib-2” page. An exemplary HTML file generated according to the invention is shown in FIG. 9. This file may be used to create the web file shown in FIG. 8.

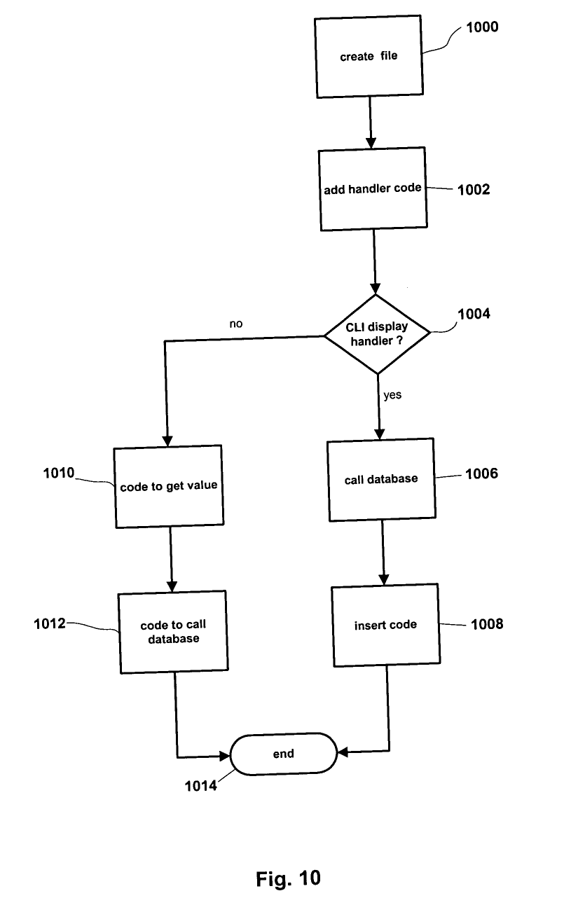

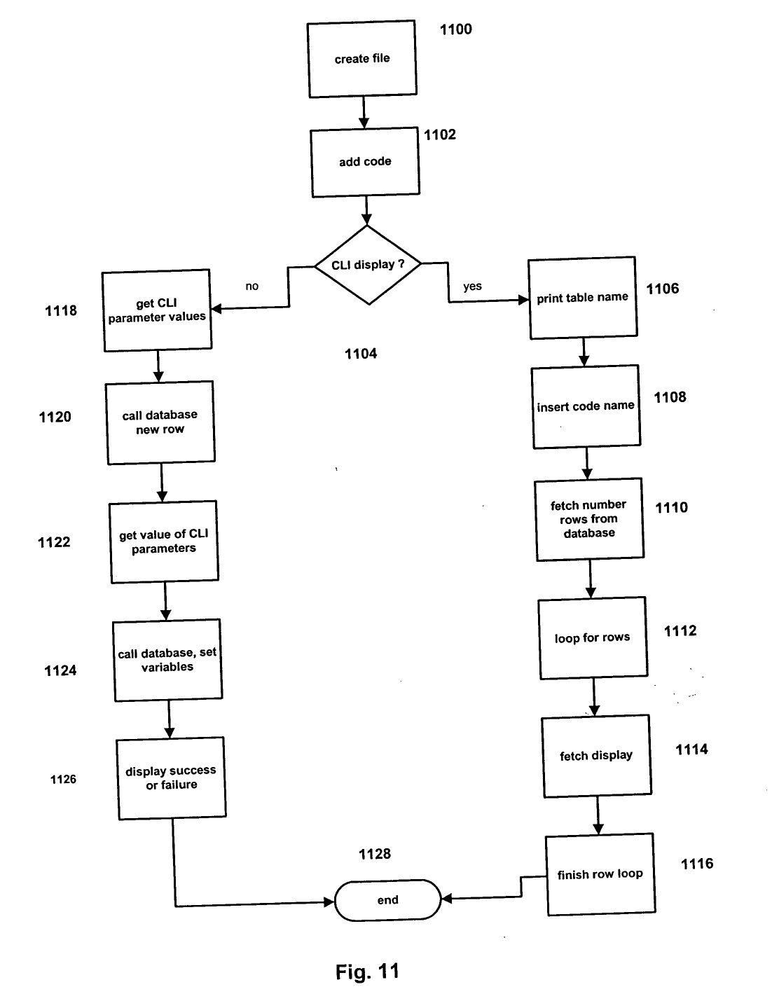

In one exemplary embodiment of the invention, the developer may be given the option to create handler functions to carry out the functions required to access the variables specified by the CLI command tree representation of the source MIB objects. For example, a handler function editor may be provided to enter the parameters and commands required for the handler function, and a handler generation engine may be included together with the GUI engine to generate the code of the handler function. One exemplary embodiment of the process to generate the CLI handler is described below, with reference to the flowcharts shown in FIGS. 10 and 11.

FIG. 10 shows the steps used to generate a handler for CLI scalar objects, according to one exemplary embodiment of the invention. In step 1000 the developer creates a new CLI handler file and names it after the source node name tree, for example “ShowSystemSysName”. Various code segments are added to the handler file in step 1002. For example, code for the new handler declaration is added, assigning to the handler a name based on the source node name tree. Code to provide for local variables is added, and preamble code may be added, to set up the handler's local buffer and input parameter validity check. For example, these code elements could test inputs and return an error if the input structures are null pointers.

The handler generation process determines in step 1004 if a CLI display handler is being generated. If it is, the process inserts a call to database to retrieve the scalar's value to the local buffer in step 1006, and inserts code to display the scalar's name and print the scalar's value from the local buffer in step 1008, before ending in step 1014. If step 1004 determines that a CLI display handler is not being generated, step 1010 is reached, in which code is inserted to obtain the value of a parameter from the passed CLI environment. Step 1012 inserts code that calls the database and sets the scalar to the parameter's value. Step 1014 then concludes the handler generation.

If the CLI handler being generated is for a CLI table, some additional steps are required. As shown in the flowchart of FIG. 11, the CLI table handler generation process starts with step 1100, in which a new CLI handler file is created using the source node name tree, as described above. Step 1102 adds code for the new handler declaration, assigning the handler a name based on the source node name tree. Code is added to provide local variables, including a data pointer named for each of the table's columns. Preamble code is added, to set up the handler's local buffer and input parameter validity checks, for example to test the input and return an error if input structures are NULL pointers.

Step 1104 determines whether the handler is a CLI display handler. If it is, execution continues to step 1106, where code is inserted to print the table's name. In step 1108, for each of the table's columns code is inserted for a command to print the column's name, and for each of the table's columns code is inserted to print underline characters for the column names. The process then inserts code that fetches from the database the value of each column value for the current row being addressed, and prints the returned value in step 1110. A loop to process each column is started in step 1112, where code is inserted to sequentially address all the rows of the table. The loop control continues in step 1114, where code is inserted to fetch from the database the value of each column location for the current row, and to print the returned value. Code is also inserted to advance the display to the next line. The loop control is terminated in step 1116, by including code that finishes the table row loop, and sends the process to step 1128, described below.

Step 1118 is reached from step 1104 if the handler is not a CLI display handler. In step 1118, code is inserted to obtain the values of the index-related CLI-passed parameters, for example using the named parameter pointers determined in step 1102. Code to call the database and find the table's column that matches the “instance” indicated by the index parameters is inserted in step 1120, together with code to call the database and insert a new row, if the row was not found in the previous step. Code is inserted in step 1122 to obtain the values of CLI-passed parameters that will be used to set the data columns, using the named parameter pointers from step 1102. In step 1124 code is inserted that calls the database and sets the table's column data values at the row found in step 1120. Code is added in step 1126 that displays at the CLI console the success or failure of the request. The CLI table handler generation concludes in step 1128, where code is added to end the function, and the process stops.

Table I shows exemplary handler code, generated according to embodiments of the present invention. This code may be generated automatically as described above, following inputs of the developer. After generation, the CLI handler code may be used to access the device to which belongs the source MIB objects.

```
TABLE I
*
* CLI Handler for “show table at atTable”
*/
extern STATUS
ShowTableAtAtTable(cli_env *pCliEnv, paramList *pParams, sbyte *pAuxBuf){
  STATUS status = OK;
  char *pOutputBuf,*pStringBuf;
  int outputLen;
  pOutputBuf = (sbyte*)malloc( kOUTPUT_BUFFER_SIZE );
  if ( NULL == pOutputBuf )
    return ERROR_MEMMGR_NO_MEMORY;
  pStringBuf = (sbyte*)malloc( kOUTPUT_BUFFER_SIZE );
  if ( NULL == pStringBuf )
      { free( pOutputBuf );
    return ERROR_MEMMGR_NO_MEMORY; }
      /* Print Table Header */
      CLI_EXT_WriteStr(pCliEnv, “[atTable]”);
      CLI_EXT_WriteStrLine(pCliEnv, pOutputBuf);
      CLI_EXT_WriteStrLine(pCliEnv, “”);
      sprintf(pStringBuf,“%20s %20s %20s”,“atlfIndex”,“atNetAddress”,“atPhysAddress”);
      CLI_EXT_WriteStrLine(pCliEnv, pStringBuf);
      char *strUnderline = “==================== ”;
      sprintf(pStringBuf,“%20s %20s %20s”,strUnderline,strUnderline,strUnderline);
      CLI_EXT_WriteStrLine(pCliEnv, pStringBuf);
      /* Print the table rows */
      int tableMax = 0;
      tableMax = wmbGetTableRowCount(“atTable”);
      for (i = 0; i< tableMax; i++) {
          /* get WindMark */
          status = wmbGetTableColumnValueToString(“atTable”, i , “atlfIndex”, pOutputBuf, &outputLen );
          if ( OK == status ) {
              /* TO DO: Use the following lines for default output or replace
                with your own code */
              sprintf(pStringBuf,“%20s ”,pOutputBuf);
              CLI_EXT_WriteStrLine(pCliEnv, pStringBuf); }
          /* get WindMark */
          status = wmbGetTableColumnValueToString(“atTable”, i , “atPhysAddress”, pOutputBuf,
&outputLen );
          if ( OK == status ) {
              /* TO DO: Use the following lines for default output or replace
                with your own code */
              sprintf(pStringBuf,“%20s ”,pOutputBuf);
              CLI_EXT_WriteStrLine(pCliEnv, pStringBuf); }
          /* get WindMark */
          status = wmbGetTableColumnValueToString(“atTable”, i , “atNetAddress”, pOutputBuf,
&outputLen );
          if ( OK == status ) {
              /* TO DO: Use the following lines for default output or replace
                with your own code */
              sprintf(pStringBuf,“%20s ”,pOutputBuf);
              CLI_EXT_WriteStrLine(pCliEnv, pStringBuf); }}
free( pOutputBuf );
free( pStringBuf );
/* TO DO: Add your handler code here */
return status;
```

The code shown in Table I is simply an example of a handler code that may be generated according to the invention. Those skilled in the art will understand that the actual code being generated may differ from the code shown, depending on the options selected by the user and on the proposed function of the handler.

According to embodiments of the present invention, a CLI command tree and handler can be created from a source MIB node as described above. The MIB data node includes sufficient information about the data that a working CLI command tree and handler(s) can be created, as described above, solely from that information. For example, the included information may contain the command key words and the parameters required for generation of the handler. In a further embodiment, that same information may be attached to new CLI handlers that are generated, and may be made visible in the graphical reprsentation of the CLI tree. The user may highlight and move the graphical representation of any handler in the graphical CLI tree representation to a different part of a developing CLI tree representation. The handler may then correctly configure itself for the new location and regenerate its code such that it will work in the new location defined by its position in the CLI tree representation.

For example, If a user wishes to move the handler that shows the “atTable” from the representation of the “show table at atTable” position to a new CLI node called “show atTable”, then the user could (1) create a new CLI node called “atTable” under the “show” node (using the normal CLI edit tools) and (2) drag the graphical representation of the “atTable” handler from the representation of the first location to the representation of the new CLI command node. As explained above, the handler possesses the correct information to re-configure itself, in particular by attaching the required parameters to the new CLI node.

In a more complex CLI tree, a given parameter may be used by more than one single sub-node and the corresponding handlers attached to that sub-node. By making the parameters visible in the displayed tree representation, a user is allowed to drag the visual representation of any given parameter to a parent node represented in the same tree. Any handlers found in other branches of the tree representation (or added later) that use that parameter can reorganize themselves to use the parameter in its new location. This may be done, for example, by entering at every handler's CLI node position the value of the parameter, rather than having to enter a version of that same parameter. In this manner a CLI tree under development may be rapidly re-shaped by the developer. For example, in the case of a set of commands that modify one of many routes in a switch device, a CLI tree may appear as follows:

ip route [route_number] set ip [ip_address]

ip route [route_number] set mask [mask_param]

In this example there are two handlers, IpRouteSetlp( ) and IpRouteSetMask( ), both sharing the same “[route_number] parameter. In both of the above cases, the two new CLI handlers can insure that they are correct and complete. If the user attempts to remove parameters or place them in positions that are not correct for the handlers, the error can be detected by the program which can either prevent it or re-adjust the positions as need.

The process described above may be applied to any management system that can be organized into a tree format, not only to MIB tree objects. For example, the scalars and/or tables that are placed within a Web page may be made visible in the graphic representation of the parameters. The user can graphically move any representation of a scalar or table to any other web page, while the Web page of origin can regenerate itself to remove the missing elements. The destination Web page can also regenerate itself to include the added element. Similarly, if an entire Web page is moved to another location in the Web file tree, the affected Web page can regenerate itself to change its internal links to the new configuration.

Although the invention was described with reference to an embedded device and a specific example of a hierarchical tree with MIB objects, the invention is not limited to the exemplary embodiments described. The specification and drawings are thus to be regarded as being illustrative rather than restrictive. It will be apparent to those skilled in the art that various modifications and variations can be made in the structure and the methodology of the present invention, without departing from the spirit or scope of the invention. For example, where methods and processes are presented within this description and within the claims, it may be possible for the individual steps of these methods to be carried out in an order different than the order presented in the specification and the claims. Thus, it is intended that the present invention cover the modifications and variations of this invention provided they come within the scope of the appended claims and their equivalents.

What is claimed is:

1. A method of editing MIB objects comprising:
generating a graphical user interface to interactively edit a MIB tree including a number of MIB objects;
displaying the MIB tree in the graphical user interface as a selected graphical representation, the selected graphical representation being equivalent to the MIB tree;
providing editable fields of the selected graphical representation such that edited fields are mapped to the MIB tree; and
generating an edited MIB tree comprising the mapped edited fields.

2. The method according to claim 1, wherein the selected graphical representation is a CLI command tree.

3. The method according to claim 1, wherein the selected graphical representation comprises linked HTML web pages.

4. The method according to claim 1, further comprising compiling the edited MIB tree.

5. The method according to claim 1, further comprising selectively generating handler functions of the device corresponding to the elements of the selected graphical representation.

6. The method according to claim 1, further comprising providing a dialog box for each of the editable fields, the dialog box containing selectable edit options.

7. The method according to claim 1, wherein different elements of the MIB tree are represented with corresponding different icons in the selected graphical representation.

8. The method according to claim 1, further comprising providing add and delete commands in the selected graphical representation to respectively add nodes and delete nodes of the MIB tree.

9. The method according to claim 8, further comprising mapping the added nodes and the deleted nodes to the MIB tree.

10. The method according to claim 1, further comprising representing additional user selected nodes of the MIB tree in the selected graphical representation.

11. The method according to claim 2, further comprising providing a CLI interface to rearrange branches of the CLI command tree to a different configuration.

12. The method according to claim 11, further comprising recursively generating CLI command tree sub-nodes corresponding to sub nodes of the MIB tree.

13. The method according to claim 12, further comprising providing commands to expand and to contract nodes of the CLI command tree to respectively display and hide sub-nodes.

14. The method according to claim 1, further comprising recursively processing the nodes and sub-nodes of the MIB tree to generate corresponding command nodes of the selected graphical representation.

15. The method according to claim 2, wherein the CLI command tree comprises buttons to display an interface dialog box to import in the CLI command tree selected branches of the MIB tree.

16. The method according to claim 15, wherein the interface dialog box specifies an SNMP node to import, a target CLI command tree node, and selectable node options.

17. The method according to claim 15, wherein the interface dialog box specifies a type of handler to be generated.

18. The method according to claim 3, further comprising providing a web page interface representing selected branches of the MIB tree as linked HTML web pages.

19. The method according to claim 18, wherein the linked HTML web pages are adapted for display by a web browser on a remote networked device.

20. The method according to claim 18, further comprising providing commands to generate additional linked HTML web pages representing expanded portions of the MIB tree.

21. The method according to claim 3, further comprising providing editable fields in the HTML web pages corresponding to editable MIB tree elements.

22. The method according to claim 20, wherein HTML tags are used to link hierarchically related HTML web pages representing the MIB tree.

23. The method according to claim 3, wherein the linked HTML web pages comprise buttons to display a web interface dialog box to import in the linked HTML web pages selected branches of the MIB tree.

24. The method according to claim 23, wherein the web interface dialog box specifies a source MIB tree object to import, a target HTML file, and selectable HTML format options.

25. The method according to claim 23, wherein the web interface dialog box specifies explanatory textual messages and graphics.

26. The method according to claim 5, further comprising providing a handler function to access device variables corresponding to MIB objects represented by a CLI command tree.

27. The method according to claim 26, further comprising providing a handler function editor to enter commands and parameters to generate the handler function.

28. The method according to claim 27, wherein the handler function editor comprises a dialog box adapted to receive user-provided code to access the device variables.

29. A system for accessing MIB objects of a networked device, comprising:
a graphical user interface to display a MIB tree representing the MIB objects; and
a GUI engine to generate in the graphical user interface a selected graphical representation equivalent to the MIB tree.

30. The system according to claim 29, further comprising symbols of the graphical user interface adapted to represent nodes of the MIB tree.

31. The system according to claim 30, wherein the symbols are linked to edit boxes to edit the nodes of the corresponding MIB tree.

32. The system according to claim 29, further comprising a handler function engine to generate handler functions associated with the symbols of the graphical user interface.

33. The system according to claim 32, further comprising handler function dialog boxes to specify commands and parameters of the handler functions.

34. The system according to claim 29, wherein the GUI engine is adapted to map changes in the selected graphical representation to the corresponding MIB tree.

35. The system according to claim 29, wherein the selected graphical representation is one of a CLI command tree and linked HTML web pages.

36. A system comprising:
a MIB compiler to generate a MIB tree from MIB objects;
a GUI engine to map and display the MIB tree as a selected graphical representation; and
editable fields of the selected graphical representation adapted to receive editing instructions to modify corresponding elements of the MIB tree.

37. The system according to claim 36, wherein the selected graphical representation is one of a CLI command tree and linked HTML web pages.

38. The system according to claim 36, further comprising handler function dialog boxes adapted to receive commands and variables related to handler functions for the MIB objects.

39. The system according to claim 38, further comprising a handler engine adapted to generate the handler functions for the MIB objects.
